(19) United States
(12) Patent Application Publication
(10) Pub. No.: US 2023/0037816 A1
(43) Pub. Date: Feb. 9, 2023

(54) CONTROL DEVICE FOR MACHINE TOOL

(71) Applicant: FANUC CORPORATION, Yamanashi (JP)

(72) Inventors: Yuuki KUMAMOTO, Yamanashi (JP); Kenta YAMAMOTO, Yamanashi (JP)

(73) Assignee: FANUC CORPORATION, Yamanashi (JP)

(21) Appl. No.: 17/758,786

(22) PCT Filed: Jan. 25, 2021
(86) PCT No.: PCT/JP2021/002378

§ 371 Date: Jul. 13, 2022

(30) Foreign Application Priority Data
Jan. 27, 2020 (JP) 2020-010681

(51) Int. Cl. G05B 19/404; B23Q 15/013

(52) U.S. Cl. CPC G05B 19/404; B23Q 15/013; G05B 2219/49314

(57) ABSTRACT

Provided is a control device for a machine tool, the control device being capable of more appropriately and easily determining a swing condition. A control device 10 for a machine tool for swinging a work piece and a tool relatively to each other to perform machining, the control device 10 comprising a storage unit 15 which stores correspondence between a machining condition and a swing condition, the machining condition being at least one of specifications of the work piece, specifications of the tool, a machining method and a machining shape, a swing condition determination unit 16 which selects a swing condition to be used for the machining on the basis of the correspondence stored in the storage unit 15, and a swing command generation unit 18 which generates a swing command on the basis of the swing condition selected by the swing condition determination unit 16.

### TECHNICAL FIELD

The present disclosure relates to a control device for a machine tool.

### BACKGROUND ART

Conventionally, it is known to perform machining by relatively oscillating a workpiece and a tool. Here, for example, in oscillation cutting for shredding chips, the oscillation conditions including an oscillation frequency and an oscillation amplitude differ depending on the tool, workpiece, machining method, machining shape, and other factors. Therefore, it is necessary to reset and fine-tune the oscillation conditions for each machining program, but this process is time-consuming.

For example, Patent Document 1 discloses a technique for calculating an oscillation frequency from the diameter of a workpiece and the set length of a chip. Patent Document 2 discloses a technique for calculating the optimal value of an oscillation frequency from an acceleration/deceleration command of a machining program.
Patent Document 1: Japanese Unexamined Patent Application, Publication No. 2016-243231
Patent Document 2: Japanese Unexamined Patent Application, Publication No. 2018-181103

### DISCLOSURE OF THE INVENTION

### Problems to be Solved by the Invention

However, in the technique of Patent Document 1, as mentioned above, the oscillation conditions including an oscillation frequency and an oscillation amplitude are influenced by the tool, machining method, machining shape, etc., and therefore, it is desirable to calculate more appropriate oscillation conditions. Further, in the technique of Patent Document 2, since an oscillation amplitude cannot be determined together with an oscillation frequency, and the oscillation of the blade edge differs depending on the rigidity of the tool, the optimal value of the oscillation frequency cannot be determined only from the acceleration/deceleration command of the machining program.

Therefore, it is desirable to provide a control device for a machine tool that can determine oscillation conditions more appropriately and easily.

### Means for Solving the Problems

An aspect of the present disclosure provides a control device for a machine tool for performing machining by relatively oscillating a workpiece and a tool. The control device includes a storage unit, an oscillation condition determination unit, and an oscillation command generation unit. The storage unit stores a correspondence relationship between at least one machining condition selected from a specification of the workpiece, a specification of the tool, a machining method, and a machining shape, and an oscillation condition. The oscillation condition determination unit selects an oscillation condition to be used for the machining based on the correspondence relationship stored by the storage unit. The oscillation command generation unit generates an oscillation command based on the oscillation condition selected by the oscillation condition determination unit.

### Effects of the Invention

According to the present disclosure, it is possible to provide a control device for a machine tool that can determine oscillation conditions more appropriately and easily.

### BRIEF DESCRIPTION OF THE DRAWINGS

FIG. 1 is a functional block diagram of a control device for a machine tool according to an embodiment of the present disclosure;

FIG. 2 shows an example of the correspondence relationships between machining conditions and oscillation conditions;

FIG. 3 shows an example of determining oscillation conditions by linear interpolation; and

FIG. 4 is a flowchart showing an example of processing performed by an oscillation condition determination unit according to an embodiment of the present disclosure.

### PREFERRED MODE FOR CARRYING OUT THE INVENTION

Hereinafter, an embodiment of the present disclosure will be described in detail with reference to the drawings.

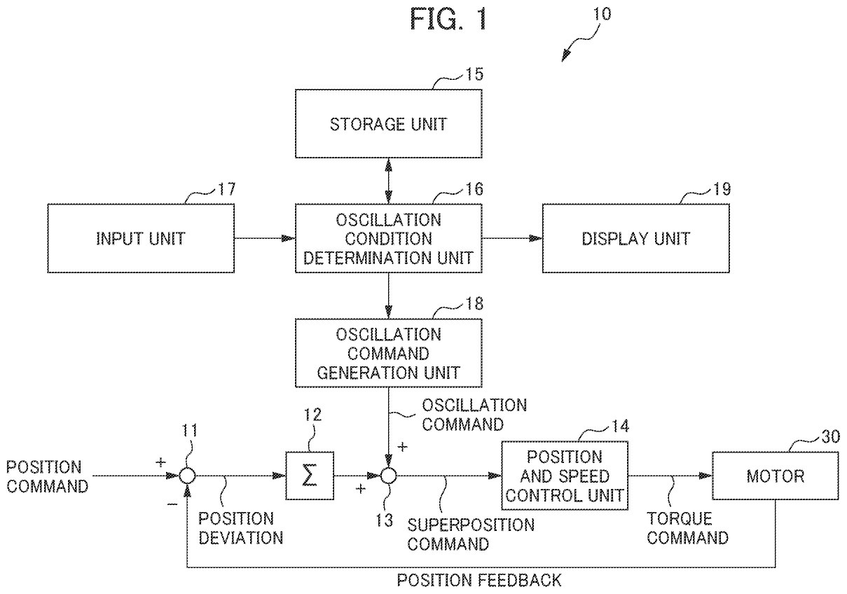

FIG. 1 is a functional block diagram of a control device 10 for a machine tool according to an embodiment of the present disclosure. The control device 10 for a machine tool controls the motor of a main shaft that relatively rotates a tool and a workpiece, and a motor 30 of a feed shaft that moves the tool and the workpiece while relatively oscillating them, thereby performing machining such as cutting, grinding, and turning. The control device 10 for a machine tool according to the present embodiment is configured by, for example, a computer having a CPU, a memory, and the like.

As shown in FIG. 1, the control device 10 for a machine tool according to the present embodiment includes adders 11 and 13, an integrator 12, a position and speed control unit 14, a storage unit 15, an oscillation condition determination unit 16, an input unit 17, an oscillation command generation unit 18, and a display unit 19.

The adder 11 calculates a position deviation. Specifically, the adder 11 calculates a position deviation that is a difference between a position feedback based on a position detection by the encoder of the motor 30 of the feed shaft and a position command for the feed shaft from a higher-level control device such as a numerical control device (not shown).

The integrator 12 calculates an integrated value of the position deviation. Specifically, the integrator 12 integrates the position deviation calculated by the adder 11 to calculate an integrated value of the position deviation.

The adder 13 generates a superposition command. Specifically, the adder 13 adds (superposes) an oscillation command generated by the oscillation command generation unit 18 described below to the integrated value of the position deviation calculated by the integrator 12 to generate a superposition command.

The position and speed control unit 14 generates a torque command for the motor 30 that drives the feed shaft based on the superposition command, and controls the motor 30 based on the generated torque command. As a result, the motor 30 that drives the feed shaft moves to a commanded position while oscillating.

The storage unit 15 stores one or more correspondence relationships between machining conditions and oscillation conditions. The machining conditions include at least one machining condition selected from a specification of the workpiece, a specification of the tool, a machining method, and a machining shape. Examples of the specification of the workpiece include the diameter and the material of the workpiece, and examples of the specification of the tool include the diameter and the number of blades of the tool. Examples of the machining method include grinding, cutting, thread cutting, and drilling, and examples of the machining shape include various shapes and sizes. The oscillation conditions include an oscillation amplitude and an oscillation frequency.

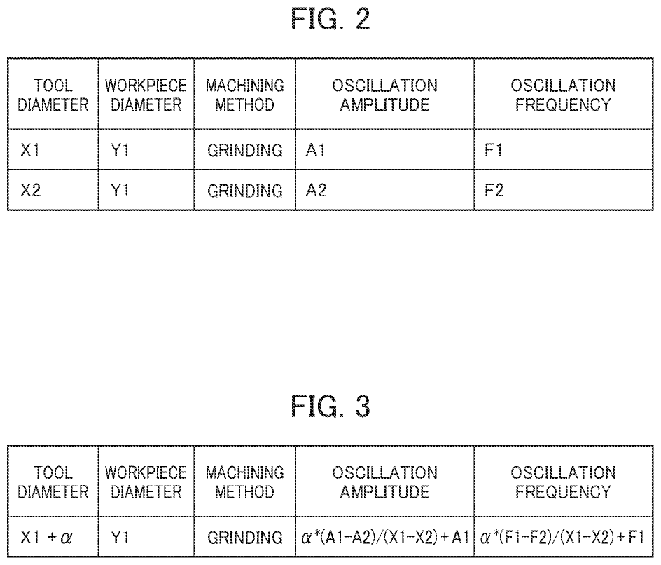

Here, FIG. 2 shows an example of the correspondence relationships between machining conditions and oscillation conditions. In the example shown in FIG. 2, an oscillation amplitude A1 and an oscillation frequency F1 as oscillation conditions are associated with machining conditions in which the tool diameter is X1, the workpiece diameter is Y1, and the machining method is grinding. In addition, an oscillation amplitude A2 and an oscillation frequency F2 as oscillation conditions are associated with machining conditions in which the tool diameter is X2, the workpiece diameter is Y2, and the machining method is grinding. These correspondence relationships between machining conditions and oscillation conditions are correspondence relationships in which evaluations were performed through actual machining and favorable evaluations were obtained. These correspondence relationships are, for example, stored in advance by the storage unit 15 at the time of designing the control device 10, or are stored by the storage unit 15 by user input.

The oscillation condition determination unit 16 selects oscillation conditions to be used for machining based on the correspondence relationships between machining conditions and oscillation conditions stored by the storage unit 15. More specifically, the oscillation condition determination unit 16 may select oscillation conditions corresponding to machining conditions input by the user based on the correspondence relationships stored by the storage unit 15 or may select oscillation conditions corresponding to machining conditions automatically determined from a machining program.

Alternatively, the oscillation condition determination unit 16 may select a plurality of candidates for oscillation conditions to be used for machining, and may allow the user to select oscillation conditions to be used for machining from the plurality of candidates. For example, when the present machining conditions are not stored by the storage unit 15, a plurality of appropriate candidates are selected as oscillation conditions to be used for machining, and oscillation conditions that are considered optimal by the user can be selected from the candidates.

Alternatively, when the present machining conditions are not stored by the storage unit 15, the oscillation condition determination unit 16 may select oscillation conditions obtained by performing interpolation based on a plurality of machining conditions stored by the storage unit 15. Alternatively, when the present machining conditions are not stored by the storage unit 15, the oscillation condition determination unit 16 may select oscillation conditions corresponding to machining conditions closer to the present machining conditions from machining conditions stored by the storage unit 15.

Here, FIG. 3 shows an example of determining oscillation conditions by linear interpolation. The machining conditions shown in FIG. 3, i.e., the machining conditions in which the tool diameter is X1+α, the workpiece diameter is Y1, and the machining method is grinding, are not stored by the storage unit 15 in the example of FIG. 2. Specifically, the machining conditions shown in FIG. 3 differ only in the tool diameter from the machining conditions in the upper and lower rows in the example of FIG. 2.

Therefore, the optimal oscillation conditions for the machining conditions shown in FIG. 3 can be determined by, for example, linear interpolation using the correspondence relationships of the upper and lower rows in FIG. 2.

Specifically, the oscillation amplitude can be determined to be α×(A1−A2)/(X1−X2)+A1, and the oscillation frequency can be determined to be α×(F1−F2)/(X1−X2)+F1. At this time, there is no limitation on the interpolation method or the number of target data.

Alternatively, since the tool diameter X1+α of the machining conditions shown in FIG. 3 is closer to the tool diameter X1 of the machining conditions shown in the upper raw of FIG. 2, the oscillation conditions corresponding to the machining conditions shown in the upper raw of FIG. 2, i.e., the oscillation amplitude A1 and the oscillation frequency F1 may be selected as oscillation conditions to be used for machining.

Returning to FIG. 1, the input unit 17 is configured to allow the user to input machining conditions to be executed this time.

The oscillation command generation unit 18 generates an oscillation command for relatively oscillating the tool and the workpiece based on the oscillation conditions selected by the oscillation condition determination unit 16.

The display unit 19 displays the input of machining conditions and the output of a selection result made by the oscillation condition determination unit 16.

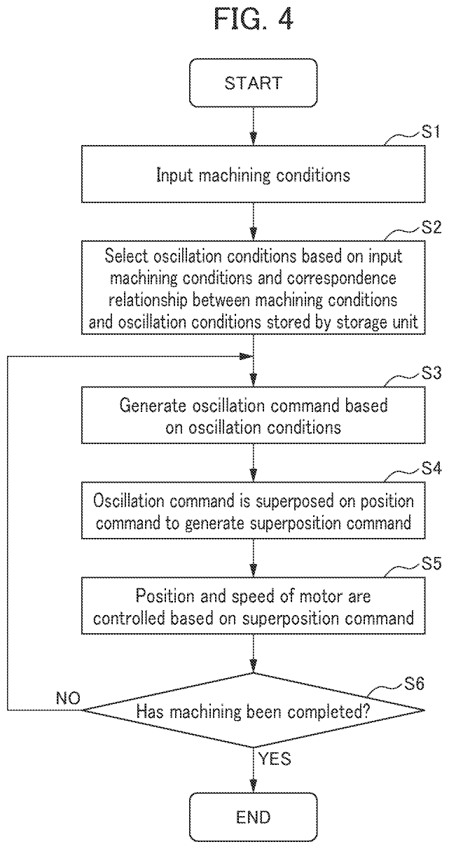

The procedure of processing performed by the oscillation condition determination unit 16 according to the present embodiment will be described in detail with reference to FIG. 4. Here, FIG. 4 is a flowchart showing an example of processing performed by the oscillation condition determination unit 16 according to the present embodiment. This example shows an example of selecting oscillation conditions based on an input by the user.

First, in Step S1, the user inputs machining conditions using the input unit. Specifically, a tool diameter, a workpiece diameter, a machining method, and the like are input. After the input, the process proceeds to Step S2.

In Step S2, oscillation conditions to be used for machining are selected based on the machining conditions input in Step S1 and the correspondence relationship between machining conditions and oscillation conditions stored in advance by the storage unit 15. After the selection, the process proceeds to Step S3.

In Step S3, an oscillation command is generated based on the oscillation conditions selected in Step S2. After the generation, the process proceeds to Step S4.

In Step S4, the oscillation command generated in Step S3 is superposed on a position command to generate a superposition command. After the generation, the process proceeds to Step S5.

In Step S5, the position and speed of the motor 30 are controlled based on the superposition command generated in Step S4.

In Step S6, it is determined whether the machining has been completed. If this determination is YES, this process is ended, and if this determination is NO, the process returns to Step S3.

According to the control device 10 for a machine tool of the present embodiment, the following effects are achieved. In the present embodiment, there are provided a storage unit 15 that stores a correspondence relationship between at least one machining condition selected from a specification of a workpiece, a specification of a tool, a machining method, and a machining shape, and an oscillation condition; an oscillation condition determination unit 16 that selects an oscillation condition to be used for machining based on the correspondence relationship stored by the storage unit 15; and an oscillation command generation unit 18 that generates an oscillation command based on the oscillation condition selected by the oscillation condition determination unit 16. Thus, an oscillation condition corresponding to the present machining condition can be selected based on the correspondence relationship between a machining condition and an oscillation condition stored in advance by the storage unit, so that the oscillation condition can be determined more appropriately and easily. In addition, since it is easy to call the oscillation condition from the storage unit, erroneous setting can be prevented, and the burden on the operator can be reduced.

In the present embodiment, an oscillation condition corresponding to a machining condition automatically determined from a machining program is selected based on the correspondence relationship stored by the storage unit 15. Accordingly, it is possible to select an appropriate oscillation condition to be used for machining based on a machining condition automatically determined from a machining program.

In the present embodiment, a plurality of candidates for the oscillation condition to be used for machining are selected, and a user can select the oscillation condition to be used for the machining from the plurality of candidates. This allows a user to select a desired oscillation condition from a plurality of candidates for the oscillation condition to be used for machining.

In the present embodiment, when the present machining condition is not stored by the storage unit 15, an oscillation condition corresponding to a machining condition closer to the present machining condition is selected from the machining conditions stored by the storage unit 15. This allows an oscillation condition corresponding to a machining condition closer to the present machining condition to be called from correspondence relationship stored and accumulated by the storage unit 15. Therefore, even when the present machining condition is not stored by the storage unit 15, the oscillation condition can be determined appropriately and easily.

In the present embodiment, when the present machining condition is not stored by the storage unit 15, an oscillation condition obtained by performing interpolation based on a plurality of the machining conditions stored by the storage unit 15 is selected. This allows an oscillation condition corresponding to a machining condition closer to the present machining condition to be estimated from correspondence relationship stored and accumulated by the storage unit 15. Therefore, even when the present machining condition is not stored by the storage unit 15, the oscillation condition can be determined appropriately and easily.

In the present embodiment, there is further provided a display unit 19 that displays an input of a machining condition and an output of a selection result made by the oscillation condition determination unit 16. Thus, an input machining condition and an oscillation condition selected corresponding to the input machining condition can be checked on the display unit 19 such as a display screen, thereby improving convenience.

The present invention is not limited to the above-described embodiments, and modifications and improvements within a range where the object of the present invention can be achieved are included in the present invention.

### EXPLANATION OF REFERENCE NUMERALS

10 control device for machine tool
11, 13 adder
12 integrator
14 position and speed control unit
15 storage unit
16 oscillation condition determination unit
17 input unit
18 oscillation command generation unit
19 display unit
30 motor

1. A control device for a machine tool for performing machining by relatively oscillating a workpiece and a tool, the control device comprising:
a storage unit that stores a correspondence relationship between at least one machining condition selected from a specification of the workpiece, a specification of the tool, a machining method, and a machining shape, and an oscillation condition;
an oscillation condition determination unit that selects an oscillation condition to be used for the machining based on the correspondence relationship stored by the storage unit; and
an oscillation command generation unit that generates an oscillation command based on the oscillation condition selected by the oscillation condition determination unit.

2. The control device for a machine tool according to claim 1, wherein the oscillation condition determination unit selects an oscillation condition corresponding to a machining condition automatically determined from a machining program based on the correspondence relationship stored by the storage unit.

3. The control device for a machine tool according to claim 1, wherein the oscillation condition determination unit selects a plurality of candidates for the oscillation condition to be used for the machining, and allows a user to select the oscillation condition to be used for the machining from the plurality of candidates.

4. The control device for a machine tool according to claim 1, wherein when a present machining condition is not stored by the storage unit, the oscillation condition determination unit selects an oscillation condition corresponding to a machining condition closer to the present machining condition from the machining conditions stored by the storage unit.

5. The control device for a machine tool according to claim 1, wherein when a present machining condition is not stored by the storage unit, the oscillation condition determination unit selects an oscillation condition obtained by performing interpolation based on a plurality of the machining conditions stored by the storage unit.

6. The control device for a machine tool according to claim 1, further comprising a display unit that displays an input of a machining condition and an output of a selection result made by the oscillation condition determination unit.
